(19) United States
(12) Patent Application Publication
(10) Pub. No.: US 2016/0129830 A1
(43) Pub. Date: May 12, 2016

(54) SELF ENERGIZED SEAT BELT TONGUE LIGHT

(71) Applicant: FORD GLOBAL TECHNOLOGIES, LLC, Dearborn, MI (US)

(72) Inventors: Mahmoud Yousef GHANNAM, Canton, MI (US); Steven Yellin SCHONDORF, Dearborn, MI (US)

(21) Appl. No.: 14/537,941

(22) Filed: Nov. 11, 2014

(51) Int. Cl. B60Q 1/26; F21V 33/00; B60R 22/34; F21V 23/04; B60R 22/18; B60R 22/02

(52) U.S. Cl. CPC B60Q 1/2661; B60R 22/18; B60R 22/023; B60R 22/34; F21V 23/0471; F21V 33/0064; B60R 2022/1806

(57) ABSTRACT

A restraint system for a vehicle includes a seat assembly and a seat belt assembly. The seat assembly includes a buckle having a buckle sensor operatively connected to a buckle light source. The seat belt assembly is associated with the seat assembly and includes a retractor, a webbing, and a tongue having a tongue light source. The buckle sensor is configured such that illumination of the tongue light source activates the buckle sensor and illuminates the buckle light source.

### TECHNICAL FIELD

This disclosure relates to passenger restraint assemblies for vehicles.

### BACKGROUND

Vehicles are equipped with restraint systems. Vehicle restraint systems aid in further minimizing passenger displacement within the vehicle. These systems generally use a belt system that extends across a vehicle seat. The seat belt restraint system uses a tongue and buckle to secure a passenger to the seat. For example, the tongue may be attached to webbing stored in a retractor. The retractor may store enough webbing to extend across the seat and allow the tongue to connect to a buckle. The buckle may be attached to a seat base. This ensures that the restraint system has adequate coverage to further prevent displacement of a vehicle passenger on a vehicle seat.

### SUMMARY

A vehicle includes a restraint system having a retractor, a webbing, a tongue connected to the retractor through the webbing, and a buckle. The buckle is configured to receive the tongue. The tongue has a first sensor configured to output a signal in response to movement associated with the tongue and a first light. The buckle has a second light. The vehicle further includes a restraint control module configured to, in response to the signal, illuminate the first and second lights.

A restraint system for a vehicle includes a seat assembly and a seat belt assembly. The seat assembly includes a buckle having a buckle sensor operatively connected to a buckle light source. The seat belt assembly is associated with the seat assembly and includes a retractor, a webbing, and a tongue having a tongue light source. The buckle sensor is configured such that illumination of the tongue light source activates the buckle sensor and illuminates the buckle light source.

A seat belt assembly includes a retractor, webbing, a tongue assembly, and a buckle. The webbing is stored within and connected to the retractor, and configured to extend across a portion of a seat. The tongue assembly is connected to the webbing, disposed opposite the retractor, and includes a light. The buckle is configured to receive the tongue assembly such that the buckle engages and locks the tongue within the buckle.

### BRIEF DESCRIPTION OF THE DRAWINGS

FIG. 1 is a schematic diagram of a vehicle;

FIG. 2 is a schematic diagram of a vehicle seat with a passenger restraint system;

FIG. 3 is a detailed view of a vehicle seat belt tongue and buckle; and

FIG. 4 is a flow diagram depicting control logic for a restraint control module.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Passenger restraint systems may further aid in preventing passenger displacement within a vehicle. However, when ambient lighting conditions are low, resulting in minimal light available to the passenger, restraint systems may not be properly utilized. This is typically due to passengers being unable to locate or identify the vehicle restraint system. Further, during situations having minimal lighting the passenger may not be able to properly attach the various parts of the passenger restraint system. Not being able to properly locate, identify, or attach the passenger restraint system may result in a passenger not using the restraint system. For example, if a passenger is unaware of the location of the restraint system, the passenger may not recognize the availability of the restraint system. Likewise, at a time during minimal available lighting, the passenger may improperly connect the components of the restraint system.

Passenger restraint systems that utilize a lighting system and an alert system may be advantageous. A passenger restraint system may be provided with a lighting system. A lighting system may include a passenger operative light on the restraint system, an autonomous light system activated through movement of the restraint system, or a light system which only deactivates lights on the restraint system when the components are properly connected. Further, the alert system may provide an indication of a restraint system not being utilized or utilized improperly. The restraint system may communicate to the passenger proper use of the vehicle restraint system. Proper use of the restraint system may further aid in preventing displacement of the passenger within the interior of the vehicle.

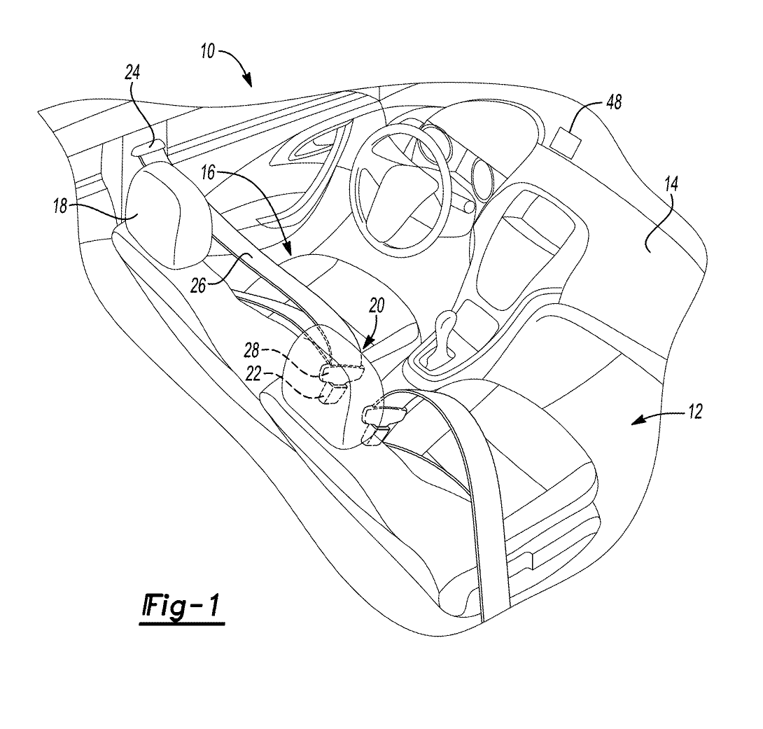

Referring to FIG. 1, a perspective view of a vehicle 10 is shown. Specifically, an interior 12 of the vehicle 10 is shown. The vehicle interior 12 includes an instrument panel 14 and a seat assembly 16. The seat assembly 16 includes a seat 18 and a restraint system 20. The restraint system 20 includes a buckle 22 disposed on the seat 18, a retractor 24 attached to the interior 12 of the vehicle 10, webbing 26 stored within and connected to the retractor 24, and a tongue 28 connected to the webbing 26 disposed opposite of the retractor 24. The restraint system may also include a restraint control module 48 in communication with instrument panel 14, the buckle 22, and the tongue 28. Communication between the control module 48, the instrument panel 14, the buckle 22, and the tongue 28 will be discussed in more detail below.

The retractor 24 may be anchored to the interior 12 of the vehicle 10 or the seat 18. The webbing 26 is configured to extend out of the retractor 24 and across the seat 18. The webbing 26 may also be anchored to the interior 12 of the vehicle 10 or the seat 18. The tongue 28 is configured to slide across the webbing 26 and connect to the buckle 22. When the tongue 28 is connected to the buckle 22, the buckle 22 engages and locks the tongue 28 within the buckle 22. This defines a buckled condition of the restraint system 20. Likewise, the buckle 22 may be configured to release the tongue 28. When the buckle 22 releases the tongue 28, the restraint system 20 is in an unbuckled condition.

The unbuckled condition of the restraint system 20 is consistent with nonuse of the restraint system 20, or an improper use of the restraint system 20. When the restraint system 20 is in the unbuckled condition, the tongue 28 and the buckle 22 are not connected, or locked together. The restraint control module 48 may be configured to send a signal indicative of the unbuckled condition to the instrument panel 14. The instrument panel 14 may provide an audible or visual alert to a passenger of the unbuckled condition upon receiving the signal from the restraint control module 48. The audio signal may be transmitted through speakers (not shown) within the interior 12 of the vehicle 10. The visual signal may illuminate a light (not shown) on the instrument panel 14 of the vehicle.

The buckled condition of the restraint system 20 is consistent with a proper use of the restraint system 20. When the restraint system 20 is in the buckled condition, the tongue 28 and the buckle 22 are connected and locked together. While the vehicle is moving, a preferred condition of the restraint system 20 may be the buckled condition. Therefore, it may be advantageous to increase awareness of when the tongue 28 and the buckle 22 are engaged and locked together to define the buckled condition of the restraint system 20. A restraint system 20 having a lighting system 30 may provide awareness of when the restraint system 20 defines the buckled condition.

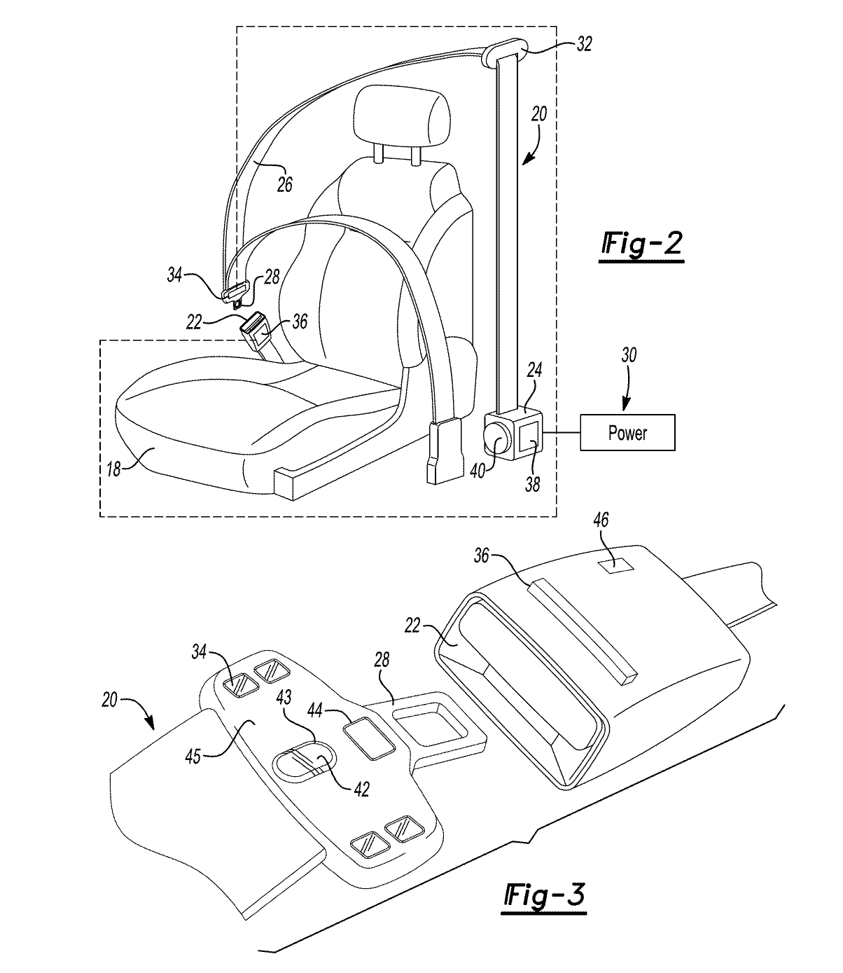

Referring to FIG. 2, a vehicle seat 18 and restraint system 20 having a lighting system 30 is depicted. The restraint system 20 may further include a ring assembly 32. The ring assembly 32 may be configured to guide the webbing 26 as it extends from the retractor 24 and across the seat 18. The lighting system 30 of the restraint system 20 includes a first light 34 disposed on the tongue 28 defining a tongue light source 34. In at least one other embodiment, the lighting system 30 of the restraint system 20 may also include a second light 36 disposed on the buckle 22 defining a buckle light source 36. The buckle light source 36 will be discussed in more detail when referencing other Figures.

In order to illuminate the tongue light source 34, energy needs to be harvested and stored. The energy needed to illuminate tongue light source 34 may be powered by an external source such as a battery 38. However in at least one embodiment, the restraint system 20 may be configured to harvest and store the energy needed to illuminate the tongue light source 34. For example, the retractor 24 may include an internal battery or capacitor 38 configured to store energy. The retractor 24 may therefore include any device capable of storing energy. In at least one other embodiment, the tongue 28 may also include an internal battery or capacitor 38 configured to store energy. The tongue 28 may therefore also include any device capable of storing energy.

Once generated and stored, energy may be harvested in a variety of ways. In at least one embodiment, friction energy may be generated through sliding the tongue 28 along the webbing 26. The tongue 28 may be configured to transfer and convert the friction energy into electrical energy to power the tongue light source 34. This would allow the lighting system 30 to be a self-powering system.

Using the friction energy example described, if more energy were needed to power the lighting system 30, the tongue 28 could be continuously slid along the webbing 26 until enough energy has been harvested. Other examples in which the restraint system 20 may be used to generate energy required to power the lighting system 30 include, but are not limited to, a mechanical system that generates kinetic energy, a magnet and coil system, as well as pressure energy using a fluidics geometry design. For example, the retractor 24 may include a rod 40. The rod 40 may be used to coil the webbing 26 within the retractor 24. As the webbing 26 extends from the retractor 24, the rod 40 may rotate. Rotation of the rod 40 may engage a mechanical system which pressurizes fluid, compresses a spring, or rotates gears to generate kinetic energy.

The kinetic energy may then be harvested in order to power the lighting system 30. For example, after energy has been generated through the interaction between the tongue 28 and the webbing 26, the energy may be converted to the necessary form in order to power the built in lighting system 30. In at least one embodiment, the lighting system 30 may require electrical energy to illuminate the tongue light source 34. However, the lighting system 30 may also use other energy such as, but not limited to, thermal energy, magnetic energy, and chemical energy in order to illuminate the tongue light source 34.

Referring to FIG. 3, a magnified perspective view of the tongue 28 and buckle 22 of the vehicle restraint system 20 is shown. As stated above, the tongue 28 may include a tongue light source 34. The tongue light source 34 may be an incandescent bulb, an LED bulb, a reflective surface, a fluorescent fluid, or any other material that reflects light. The tongue light source 34 may include a single light source or a plurality of light sources. The tongue 28 may also include a button 42. Activation of the button 42 illuminates the tongue light source 34 of the lighting system 30. Activation of the button 42 may include applying pressure to the button 42, applying a thermal load to the button 42, completing an electrical circuit such as through a switch, or through receiving commands from the restraint control module 48.

For example, a vehicle passenger may activate the button 42 by pressing the button 42, moving an appendage on top of the button 42, or by squeezing the button 42 at a defined location 43 on an external surface 45 of the tongue 28. The defined location 43 for the button 42 on the external surface 45 of the tongue 28 may be designated in a plurality of ways. The defined location 43 may be highlighted, colored, or shaped by design allowing the button 42 to be easily identified. For example, the defined location 43 for the button 42 may be a location where a passenger typically grips the tongue 28. Further, the tongue light source 34 may also act as a flash locator. For example, constant pressure on the button 42 may provide constant illumination of the tongue light source 34. Constant illumination of the tongue light source 34 may allow a vehicle passenger to use the tongue light source 34 to identify other objects or instruments within the vehicle.

Further, illumination of the tongue light source 34 may include constant illumination, or intermittent illumination at a predefined frequency or frequencies. For example, the frequency of an intermittent illumination may increase or decrease as the proximity between the tongue 28 and the buckle 22 increases or decreases. Likewise, the tongue light source 34 may include a plurality of wavelengths defining color. For example, the tongue light source 34 may be a single color, or change colors, such as from red to yellow and yellow to green as the tongue 28 extends toward and engages with the buckle 22.

Illumination of the tongue light source 34 may also be timed. Timing of illumination of the tongue light source 34 may be a period of time during which the tongue light source 34 provides light before turning off. Deactivating, or turning off, the tongue light source 34 may be accomplished in a variety of ways. Deactivation of the tongue light source 34 may include applying pressure to the button 42, applying a thermal load to the button 42, or by controlling an electrical circuit. For example, a built in electrical circuit may be coded to allow the tongue light source 34 to illuminate for a given period of time once pressure is applied to the button 42. Likewise, an electrical circuit may also be coded to deactivate the tongue light source 34 once a passenger moves an appendage away from the button 42.

Further, the restraint control module 48 may be configured to deactivate, or turn off the tongue light source 34, after the tongue 28 connects and engages with the buckle 22. The tongue 28 and the buckle 22 may also include a tongue sensor 44 and a buckle sensor 46. As stated above, the buckle 22 may also include a buckle light source 36. The buckle light source 36 may be an incandescent bulb, an LED bulb, a reflective surface, a fluorescent fluid, or any other material that reflects light. The buckle light source 36 may include a single light source or a plurality of light sources. Further, illumination of the buckle light source 36 may include constant illumination, or intermittent illumination at a predefined frequency. The buckle light source 36 may include a plurality of wavelengths defining color. For example, the buckle light source 36 may be a single color, or change colors, such as from red to yellow and yellow to green as the tongue 28 extends toward and engages with the buckle 22.

The buckle sensor 46 may be operatively connected to the buckle light source 36. Likewise, the tongue sensor 44 may be operatively connected to the tongue light source 34. For example, the tongue and buckle sensors 44, 46 may be proximity sensors. Therefore, as the tongue 28 extends toward the buckle 22, the tongue and buckle light sources 34, 36 may illuminate based on the proximity between them. As stated above, the tongue and buckle light sources 34, 36 may illuminate intermittently. For example, the frequency of the intermittent illumination may increase or decrease as the proximity, via the tongue and buckle sensors 44, 46, between the tongue 28 and the buckle 22 increases or decreases. Also, the wavelength emitted from the tongue light source 34 and the buckle light source 36 may define the same color or different colors. These colors may also change based on the proximity, via the tongue and buckle sensors 44, 46, of the tongue 28 and the buckle 22. Communication of engagement between the restraint control module 48 and the tongue 28 and the buckle 22, regarding operation of the lighting system 30, will be discussed in more detail below.

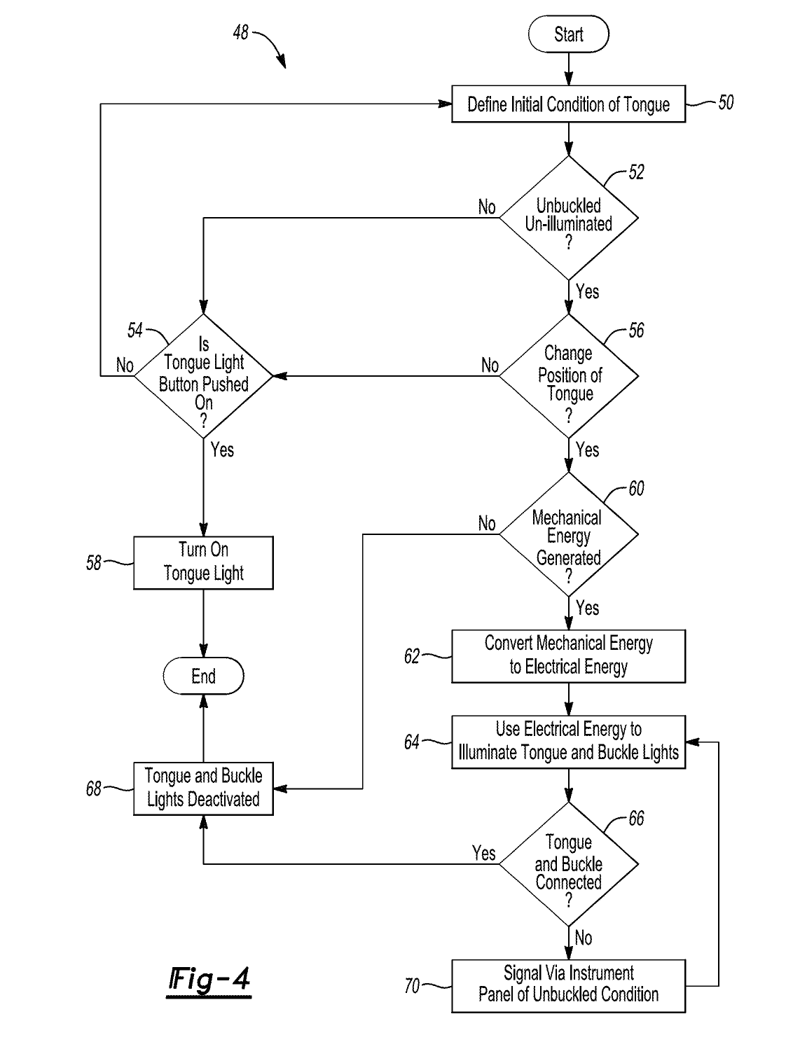

Referring to FIG. 4, a control logic flow diagram for a restraint control module 48 depicting operation of the lighting system 30 on the restraint system 20 is shown. The vehicle 10 may further include a controller 48, or restraint control module associated with the restraint system 20. The controller 48 may employ control logic controlling illumination states of the tongue light source 34 on the tongue 28 and the buckle light source 36 on the buckle 22. The controller 48 may be configured to send and receive signals to and/or from the tongue sensor 44 and the buckle sensor 46. The signals transmitted by the controller 48 may be indicative of proximity between the tongue 28 and the buckle 22, illumination of the tongue light source 34 or the buckle light source 36, the energy of the lighting system 30, or strength of the signals between the tongue sensor 44 and the buckle sensor 46.

The controller 48 may, at 50, define an initial condition of the tongue 28. The initial condition of the tongue 28 utilizes the tongue sensor 44 and the tongue light source 34 to define the state of the tongue position and tongue light source 34. For example, at 50 the controller 48 may determine the distance between the tongue sensor 44 and the buckle sensor 46 as being consistent with the unbuckled condition described above. At 52, the controller 48 may determine if the tongue light source 34 is illuminated. If at 52 the tongue light source 34 is not illuminated, the controller 48 may determine, at 54, if the button 42 on the tongue 28 is activated. Activating the button 42, at 54, is consistent with the activation modalities described above. If the button 42, at 54, is not active, the controller 48 may define the initial condition of the tongue at 50. If however at 54 the button 42 is active, at 58 the tongue light source 34 will be illuminated as described above.

If, however, at 52 the controller 48 determines that the tongue light source 34 has been illuminated as described above, the controller 48 may at 56 determine if the tongue 28 has changed position. If at 56 the tongue 28 has not changed position, the controller may determine if the button 42 on the tongue 28 is active at 54 as described above. If at 56 the controller 48 determines that the tongue 28 has changed position, the controller 48 may determine if energy has been generated at 60. At 60, at least one embodiment describes generation of mechanical energy between sliding the tongue 28 on the webbing 26 as described above. However at 60 any other method used to generate energy, as described above, may also be contemplated.

If at 60 energy has not been generated, the tongue light source 34 and the buckle light source 36 may be deactivated. This may be due to the lack of energy being provided to the tongue light source 34 and the buckle light source 36 based on the lack of energy generated at 60. Further, the controller 48 may be configured to activate the tongue light source 34 and the buckle light source 36 only if sufficient energy has been generated at 60 to the power the tongue and buckle light sources 34, 36. If energy is generated at 60, the controller 48 may then command the lighting system 30 to convert the generated energy at 60 into energy necessary to illuminate the tongue light source 34 and the buckle light source 36 at 62. For example, if mechanical energy is generated at 60, the controller 48 may command the lighting system 30 to convert the mechanical energy into electrical energy at 62. The electrical energy may then be used to illuminate the tongue light source 34 and the buckle light source 36 at 64.

The controller 48 may determine, at 66, if the tongue 28 and the buckle 22 are connected and engaged. As stated above, engagement between the buckle 22 and the tongue 28 is consistent with the buckled position of the restraint system 20. Further as stated above, the tongue 28 may include a first sensor 44 corresponding to the tongue sensor 44 and the buckle 22 may include a second sensor 46 corresponding to the buckle sensor 46. Communication between the first sensor 44 and the second sensor 46 aids the controller 48 in determining whether the tongue 28 and the buckle 22 are connected at 66. The sensing and communication between the first sensor 44 and the second sensor 46 may include magnetic field induction between the tongue 28 and the buckle 22, recognized barcodes on the tongue 28 and the buckle 22, laser proximity sensors, ultrasonic proximity sensors, or any other noncontact type displacement fast response proximity sensors. In at least one embodiment, sensing between the tongue 28 and the buckle 22 may use electro-optical proximity detector sensors.

Use of electro-optical proximity detector sensors allows the controller 48, at 64, to illuminate the buckle light source 36 if the tongue light source 34 illuminates at 58, 64. The tongue light source 34 and the buckle light source 36 may illuminate when the tongue 28 and the buckle 22 are not connected at 66. Illuminating the buckle light source 36 upon illumination of the tongue light source 34 further aids in identifying the components of the vehicle restraint system 20. Identifying the components of the vehicle restraint system 20 further promotes engagement between the tongue 28 and the buckle 22. Promoting engagement between the tongue 28 and the buckle 22 further encourages use of the preferred buckled condition of the vehicle restraint system 20.

If, at 66, the proximity between the first sensor 44 and the second sensor 46 indicate the unbuckled condition, then the controller 48 at 66 may command continuous illumination of the tongue light source 34 and the buckle light source 36 at 64 until the buckled condition is detected at 66. The first sensor 44 and the second sensor 46 send signals indicative of the unbuckled condition when the distance between the first and second sensors 44, 46 is above a threshold. Likewise, the first and second sensors 44, 46 send signals indicative of the buckled condition when the distance between the first and second sensors 44, 46 is below a threshold. The threshold distance may, for example, be less than 6 inches.

Further, if at 66 the controller 48 receives signals indicating that the tongue 28 and the buckle 22 are not connected, via the first and second sensors 44, 46, the controller 48 may signal the unbuckled condition through an instrument panel at 70. Signaling the unbuckled condition through the instrument panel at 70 may provide an alert to a passenger of the unbuckled condition of the restraint system 20. Alerting a passenger of the unbuckled condition of the restraint system 20 may further promote the preferred buckled condition of the restraint system 20. The controller 48 may utilize an audio or visual alert through the instrument panel at 70. For example, the audio and/or visual alert may include illumination of a light on the instrument panel, or through audible or visual text on or through the instrument panel. If at 66 the controller 48 determines that the tongue 28 and the buckle 22 are connected, using the first and second sensors 44, 46, the controller 48 may command the vehicle lighting system 30 to turn off the tongue light source 34 and the buckle light source 36 at 68.

While illustrated as one controller, the controller 48 may be part of a larger control system and may be controlled by various other controllers throughout the vehicle 10, such as a vehicle system controller (VSC). The controller 48 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A vehicle comprising:
a restraint system including a retractor, a webbing, a tongue connected to the retractor through the webbing, and a buckle configured to receive the tongue, the tongue having a first sensor configured to output a signal in response to movement associated with the tongue and a first light, and the buckle having a second light; and
a restraint control module configured to, in response to the signal, illuminate the first and second lights.

2. The vehicle of claim 1 further comprising a second sensor disposed on the buckle.

3. The vehicle of claim 2 wherein the restraint control module is further configured to, in response to receiving a second signal from the second sensor, turn off the first and second lights.

4. The vehicle of claim 2 wherein the first and second sensors are non-contact sensors.

5. The vehicle of claim 1 wherein the restraint control module is further configured to, in response to receiving the signal, transmit a buckle position signal to an instrument panel assembly.

6. A restraint system for a vehicle comprising:
a seat assembly including a buckle having a buckle sensor operatively connected to a buckle light source; and
a seat belt assembly associated with the seat assembly and including a retractor, a webbing, and a tongue having a tongue light source, wherein the buckle sensor is configured such that illumination of the tongue light source activates the buckle sensor and illuminates the buckle light source.

7. The restraint system of claim 6 wherein the buckle sensor is an electro-optical proximity detector sensor.

8. The restraint system of claim 6 further comprising a tongue sensor operatively connected to the tongue light source.

9. The restraint system of claim 8 wherein the tongue sensor is a laser proximity sensor.

10. The restrain system of claim 8 further comprising a controller configured to, in response to a distance between the tongue sensor and the buckle sensor being less than a threshold, turn off the tongue light source and the buckle light source.

11. The restraint system of claim 6 further comprising a battery disposed on the tongue and configured to store energy to power the tongue light source and the buckle light source.

12. A seat belt assembly comprising:
a retractor;
webbing, stored within and connected to the retractor, and configured to extend across a portion of a seat;
a tongue assembly connected to the webbing, disposed opposite the retractor, and including a light; and
a buckle configured to receive the tongue assembly such that the buckle engages and locks the tongue within the buckle.

13. The seat belt of claim 12 further comprising a button disposed on the tongue and configured such that pressure on the button activates the light.

14. The seat belt of claim 12 further comprising a battery disposed within the retractor and configured to store energy.

15. The seat belt of claim 14 wherein the battery is configured to provide energy to power the light.

16. The seat belt of claim 14 wherein the tongue is configured to generate energy in response to the tongue sliding on the webbing.

17. The seat belt of claim 14 further comprising a rod disposed within the retractor and configured such that movement of the webbing across the rod generates energy stored within the battery.
